(19) United States
(12) Patent Application Publication
(10) Pub. No.: US 2013/0155018 A1
(43) Pub. Date: Jun. 20, 2013

(54) DEVICE AND METHOD FOR EMULATING A TOUCH SCREEN USING FORCE INFORMATION

(71) Applicant: SYNAPTICS INCORPORATED, Santa Clara, CA (US)

(72) Inventor: Nuri Dagdeviren, San Jose, CA (US)

(73) Assignee: SYNAPTICS INCORPORATED, Santa Clara, CA (US)

(21) Appl. No.: 13/719,663

(22) Filed: Dec. 19, 2012

Related U.S. Application Data
(60) Provisional application No. 61/578,081, filed on Dec. 20, 2011.

(51) Int. Cl. G06F 3/041

(52) U.S. Cl. CPC G06F 3/0414
USPC 345/174

(57) ABSTRACT

Methods, systems and devices are described for operating an electronic system to emulate a touch sensitive interface using a touchpad and a display screen which does not overlap the touchpad. The method includes determining positional information and force information for an input object in a sensing region of the touchpad; positioning an input object representation on the display screen based on the positional information; selecting a user selectable item on the display screen based on the force information satisfying a first force threshold; and activating the selected item based on the force information satisfying at least one of the first force threshold and a second force threshold.

### PRIORITY INFORMATION

This application claims priority to U.S. Provisional Patent Application Ser. No. 61/578,081, filed Dec. 20, 2011.

### FIELD OF THE INVENTION

This invention generally relates to electronic devices, and more specifically relates to sensor devices and using sensor devices for producing user interface inputs.

### BACKGROUND OF THE INVENTION

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

The proximity sensor device can be used to enable control of an associated electronic system. For example, proximity sensor devices are often used as input devices for larger computing systems, including: notebook computers and desktop computers. Proximity sensor devices are also often used in smaller systems, including: handheld systems such as personal digital assistants (PDAs), remote controls, and communication systems such as wireless telephones and text messaging systems. Increasingly, proximity sensor devices are used in media systems, such as CD, DVD, MP3, video or other media recorders or players. The proximity sensor device can be integral or peripheral to the computing system with which it interacts.

Some input devices also have the ability to detect applied force in addition to determining positional information for input objects interacting with a sensing region of the input device. However, in presently known input devices, the force component is typically binary. This limits the flexibility and usability of presently known force enabled input devices.

Touch screen technology allows a user to tap directly on a display screen, and launch or otherwise activate an icon or other user selectable item from the display. Indeed, many operating systems rely on such direct user input to through a touch screen interface. However, touch screen hardware is expensive, particularly for the relatively large screen sizes associated with laptop and notebook computers. The present inventors have determined that it may be desirable to emulate the user experience and functionality of a touch screen without the cost of the hardware.

### BRIEF SUMMARY OF THE INVENTION

Embodiments of the present invention provide a device and method that facilitates improved device usability. The device and method provide improved user interface functionality by using force information to emulate the behavior of a touch screen, allowing the user to interact with a direct input device (e.g., touch screen) using an indirect pointing device, such as a force enabled touchpad (also called a force pad). Instead of the user actually touching the screen, a driver associated with the force pad injects phantom touch information into the data stream between the input device and the operating system of the host computer. The operating system processes the phantom touch information in the same manner as if actual touch screen hardware had been employed.

The force enabled touchpad is configured to operate in a first mode in which it positions a cursor on the display screen in a traditional manner using positional information, and in a second mode in which the input device emulates the behavior of a touch screen using force information. In the second mode of operation, positional information is used to position an input object representation (e.g., finger blob, orb, pointer, etc.) on the display screen using a light touch. The user positions the input object representation on the display by applying a light touch to the touchpad, and launches or otherwise activates the selected item via a subsequent action, such as lifting (releasing) the input object from the touchpad, or pressing harder on the touchpad.

The force enabled touchpad of the present invention may be configured to switch (or toggle) between the first (cursor) and second (emulation) operational modes manually or automatically. Manual mode switching may be implemented through any desired combination of positional and/or force information, such as a three finger “click”. In other embodiments, mode switching may be based on an instruction from the host operating system or from a software application running on the host. As an example, mode switching may be implemented in a context specific manner, such as by switching to emulation mode when an application anticipated receiving touch screen input from the user.

It should also be noted that when the input device is operated in touch screen emulation mode, finger movement on the touchpad which might otherwise be interpreted as a gesture may be suppressed to avoid inadvertent activation of items not intended by the user.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary electronic system that includes an input device and a processing system in accordance with an embodiment of the invention;

FIG. 2 is a flow chart of a method of operating an electronic system to emulate a touch sensitive surface using a touchpad in accordance with an embodiment of the invention;

FIG. 3 is a schematic view of an exemplary processing system in accordance with an embodiment of the invention; and

FIG. 4 is a force level mapping diagram in accordance with an embodiment of the invention

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention provide input devices and methods that facilitate improved usability. User interface functionality may be enhanced by integrating a force sensor (or multiple force sensors) into the touchpad to create a new interaction model in which a force enabled touchpad may be configured to emulate a touch screen user experience.

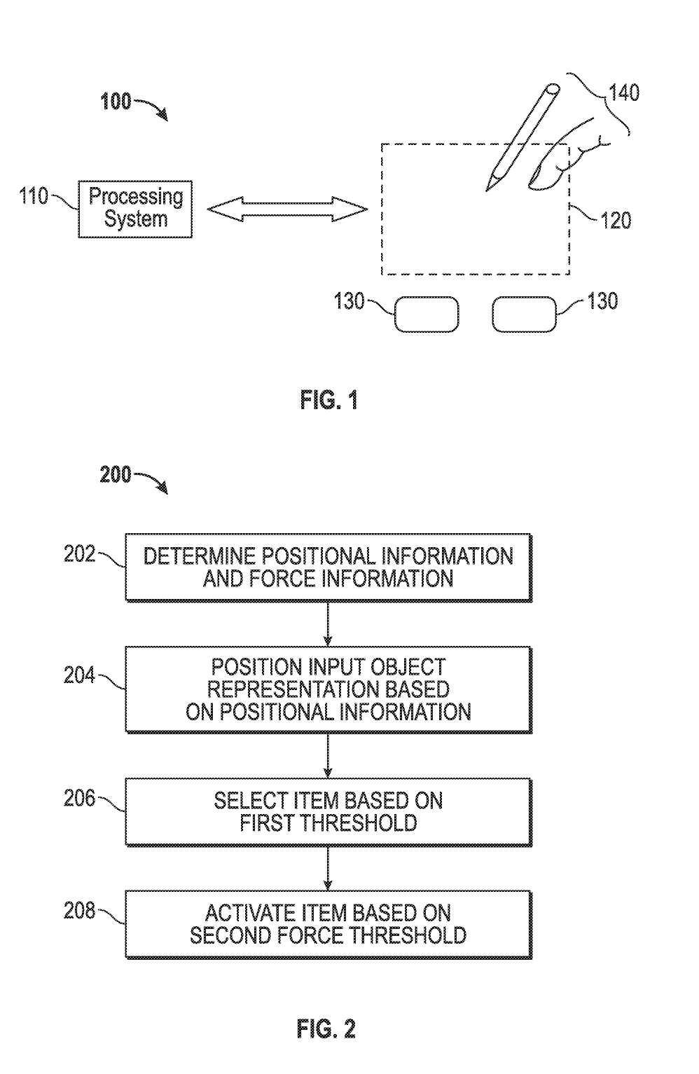

Turning now to the figures, FIG. 1 is a block diagram of an exemplary input device 100 in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In a preferred embodiment, the input device 100 is implemented as a force enabled touchpad system including a processing system 110 and a sensing region 120. Sensing region 120 (also often referred to as “touchpad”) is configured to sense input provided by one or more input objects 140 in the sensing region 120. Example input objects include fingers, thumb, palm, and styli. The sensing region 120 is illustrated schematically as a rectangle; however, it should be understood that the sensing region may be of any convenient form and in any desired arrangement on the surface of and/or otherwise integrated with the touchpad.

Sensing region 120 includes sensors for detecting force and proximity, as described in greater detail below in conjunction with FIG. 2. Sensing region 120 may encompass any space above (e.g., hovering), around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device is adapted to provide user interface functionality by facilitating data entry responsive to the position of sensed objects and the force applied by such objects. Specifically, the processing system is configured to determine positional information for objects sensed by a sensor in the sensing region. This positional information can then be used by the system to provide a wide range of user interface functionality. Furthermore, the processing system is configured to determine force information for objects from measures of force determined by the force sensor(s). This force information can then also be used by the system to provide a wide range of user interface functionality. For example, by providing different user interface functions in response to different levels of applied force by objects in the sensing region. Furthermore, the processing system is configured to determine input information for object sensed in the sensing region. Input information can be based upon a combination the force information, the positional information, the number of input objects in the sensing region and/or in contact with the input surface, and a duration the one or more input objects is touching or in proximity to the input surface. Input information can then be used by the system to provide a wide range of user interface functionality.

The input device is sensitive to input by one or more input objects (e.g. fingers, styli, etc.), such as the position of an input object within the sensing region. The sensing region encompasses any space above, around, in and/or near the input device in which the input device is able to detect user input (e.g., user input provided by one or more input objects). The sizes, shapes, and locations of particular sensing regions may vary widely from embodiment to embodiment. In some embodiments, the sensing region extends from a surface of the input device in one or more directions into space until signal-to-noise ratios prevent sufficiently accurate object detection. The distance to which this sensing region extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device, contact with an input surface (e.g. a touch surface) of the input device, contact with an input surface of the input device coupled with some amount of applied force, and/or a combination thereof In various embodiments, input surfaces may be provided by surfaces of casings within which the sensor electrodes reside, by face sheets applied over the sensor electrodes or any casings.

The electronic system 100 may utilize any combination of sensor components and sensing technologies to detect user input (e.g., force, proximity) in the sensing region 120 or otherwise associated with the touchpad. The input device 102 comprises one or more sensing elements for detecting user input. As several non-limiting examples, the input device 100 may use capacitive, elastive, resistive, inductive, magnetic, acoustic, ultrasonic, and/or optical techniques.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

It should also be understood that the input device may be implemented with a variety of different methods to determine force imparted onto the input surface of the input device. For example, the input device may include mechanisms disposed proximate the input surface and configured to provide an electrical signal representative of an absolute or a change in force applied onto the input surface. In some embodiments, the input device may be configured to determine force information based on a defection of the input surface relative to a conductor (e.g. a display screen underlying the input surface). In some embodiments, the input surface may be configured to deflect about one or multiple axis. In some embodiments, the input surface may be configured to deflect in a substantially uniform or non-uniform manner In various embodiments, the force sensors may be based on changes in capacitance and/or changes in resistance.

In FIG. 1, a processing system 110 is shown as part of the input device 100. However, in other embodiments the processing system may be located in the host electronic device with which the touchpad operates. The processing system 110 is configured to operate the hardware of the input device 100 to detect various inputs from the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as graphical user interface (GUI) actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions. The types of actions may include, but are not limited to, pointing, tapping, selecting, clicking, double clicking, panning, zooming, and scrolling. Other examples of possible actions include an initiation and/or rate or speed of an action, such as a click, scroll, zoom, or pan.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information, particularly regarding the presence of an input object in the sensing region. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

Likewise, the term “force information” as used herein is intended to broadly encompass force information regardless of format. For example, the force information can be provided for each input object as a vector or scalar quantity. As another example, the force information can be provided as an indication that determined force has or has not crossed a threshold amount. As other examples, the force information can also include time history components used for gesture recognition. As will be described in greater detail below, positional information and force information from the processing systems may be used to facilitate a full range of interface inputs, including use of the proximity sensor device as a pointing device for selection, cursor control, scrolling, and other functions.

Likewise, the term “input information” as used herein is intended to broadly encompass temporal, positional and force information regardless of format, for any number of input objects. In some embodiments, input information may be determined for individual input objects. In other embodiments, input information comprises the number of input objects interacting with the input device.

In some embodiments, the input device 100 is implemented with additional input components that are operated by the processing system 110 or by some other processing system. These additional input components may provide redundant functionality for input in the sensing region 120, or some other functionality. For example, buttons (not shown) may be placed near the sensing region 120 and used to facilitate selection of items using the input device 102. Other types of additional input components include sliders, balls, wheels, switches, and the like. Conversely, in some embodiments, the input device 100 may be implemented with no other input components.

In some embodiments, the electronic system 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

It should also be understood that the input device may be implemented with a variety of different methods to determine force imparted onto the input surface of the input device. For example, the input device may include mechanisms disposed proximate the input surface and configured to provide an electrical signal representative of an absolute or a change in force applied onto the input surface. In some embodiments, the input device may be configured to determine force information based on a defection of the input surface relative to a conductor (e.g. a display screen underlying the input surface). In some embodiments, the input surface may be configured to deflect about one or multiple axis. In some embodiments, the input surface may be configured to deflect in a substantially uniform or non-uniform manner.

As described above, in some embodiments some part of the electronic system processes information received from the processing system to determine input information and to act on user input, such as to facilitate a full range of actions. It should be appreciated that some uniquely input information may result in the same or different action. For example, in some embodiments, input information for an input object comprising, a force value F, a location X,Y and a time of contact T may result in a first action. While input information for an input object comprising a force value F′, a location X′,Y′ and a time of contact T′ (where the prime values are uniquely different from the non-prime values) may also result in the first action. Furthermore, input information for an input object comprising a force value F, a location X′,Y and a time of contact T′ may result in a first action. While the examples below describe actions which may be performed based on input information comprising a specific range of values for force, position and the like, it should be appreciated that that different input information (as described above) may result in the same action. Furthermore, the same type of user input may provide different functionality based on a component of the input information. For example, different values of F, X/Y and T may result in the same type of action (e.g. panning, zooming, etc.), that type of action may behave differently based upon said values or other values (e.g. zooming faster, panning slower, and the like).

As noted above, the embodiments of the invention can be implemented with a variety of different types and arrangements of capacitive sensor electrodes for detecting force and/or positional information. To name several examples, the input device can be implemented with electrode arrays that are formed on multiple substrate layers, typically with the electrodes for sensing in one direction (e.g., the “X” direction) formed on a first layer, while the electrodes for sensing in a second direction (e.g., the “Y” direction are formed on a second layer. In other embodiments, the sensor electrodes for both the X and Y sensing can be formed on the same layer. In yet other embodiments, the sensor electrodes can be arranged for sensing in only one direction, e.g., in either the X or the Y direction. In still another embodiment, the sensor electrodes can be arranged to provide positional information in polar coordinates, such as “r” and “θ” as one example. In these embodiments the sensor electrodes themselves are commonly arranged in a circle or other looped shape to provide “θ”, with the shapes of individual sensor electrodes used to provide “r”.

Also, a variety of different sensor electrode shapes can be used, including electrodes shaped as thin lines, rectangles, diamonds, wedge, etc. Finally, a variety of conductive materials and fabrication techniques can be used to form the sensor electrodes. As one example, the sensor electrodes are formed by the deposition and etching of conductive ink on a substrate.

In some embodiments, the input device is comprises a sensor device configured to detect contact area and location of a user interacting with the device. The input sensor device may be further configured to detect positional information about the user, such as the position and movement of the hand and any fingers relative to an input surface (or sensing region) of the sensor device.

In some embodiments, the input device is used as an indirect interaction device. An indirect interaction device may control GUI actions on a display which is separate from the input device, for example a touchpad of a laptop computer. In one embodiment, the input device may operate as a direct interaction device. A direct interaction device controls GUI actions on a display which underlies a proximity sensor, for example a touch screen. There are various usability differences between indirect and direct more which may confuse or prevent full operation of the input device. For example, an indirect input device may be used to position a cursor over a button by moving an input object over a proximity sensor. This is done indirectly, as the motion of the input does not overlap the response on the display. In a similar case, a direct interaction device may be used to position a cursor over a button by placing an input object directly over or onto the desired button on a touch screen.

In various embodiments, when emulating direct interaction by using an indirect device, a user has a limited ability to determine precisely where an input object (finger) may emulate contact on the display when touching the touchpad. Thus, there is a need to track or map (“select”) finger position on the touchpad with the corresponding location on the display (typically accomplished natively by locating a finger over the desired location on the touchscreen) before activating the selected item (accomplished natively by actually touching and/or releasing the touchscreen in the direct interaction model).

Force information may be used by the processing system to perform this “selection” or tracking function to better enable an indirect input device to simulate direct interaction. In one embodiment, shown in Table 1, direct interaction actions are mapped to an indirect input device which is configured to determine a force imparted on an input surface. The processing system performs a positioning action in response to force information comprising a light force value (called “light touch” in Table 1). Thus, in emulation mode, applying a light touch by an input object moving over a touchpad is analogous to positioning one's finger at various positions a short distance away from a display screen.

In one embodiment, selection of an item on the display is performed by applying a force greater than the light touch and which satisfies a first force threshold (called “press” in Table 1). Activation of the selected item is performed by the processing system in response to an input object leaving the touch surface. (called “lift” in Table 1). In some embodiments, activation of the selected item occurs after the force imparted by the object touching the surface has crossed a threshold. The selection of an item may be canceled by the processing system if the selected item is not activated after a certain amount of time has passed (called “time out” in Table 1).

TABLE 1
Example mappings of indirect interactions to direct interactions.

| | Indirect interaction mode | Direct interaction mode |
|---|---|---|
| Interface Action | equivalent | equivalent |
| Positioning | Light touch | Position hand prior |
| | | to touching |
| Selection | Press | Touch |
| Cancel Selection | Timeout | Timeout |
| Activation | Lift | Lift |

In another embodiment, as shown in Table 2, the selected item may be activated by applying a harder force which satisfies a second force threshold greater than the first force threshold (called “press harder” in Table 2). Alternatively, the selected item may be activated in response to the input object leaving the touch surface after performing a “hard” press.

TABLE 2
Further example mappings of indirect interactions to direct interactions.

| | | Direct |
|---|---|---|
| Interface | Indirect interaction mode | interaction mode |
| Action | equivalent | equivalent equivalent |
| Positioning | Light touch (e.g., <1^{st} force | Position hand prior |
| | threshold) | to touching |
| Selection | Press (e.g., >1^{st} force threshold) | Touch |
| Cancel | Release (e.g., <1st force | Timeout |
| Selection | threshold) | |
| Activation | Press Harder (e.g., >2^{nd} force | Lift |
| | threshold (with Release (e.g., <1sr | |
| | or 2^{nd} force threshold)) | |

In one embodiment, when a user puts their finger within the sensing region of a capacitive sensor, a graphical user interface may display the position of the finger (e.g., a finger-blob). The user can reposition the finger by sliding around the touchpad with some “light” force. This differs from the conventional indirect device behavior where sliding the finger would perform some gestural input, such as dragging or panning the interface. As such, in the conventional case there may be no opportunity to correct positioning. Once the finger is positioned over the target, a press (first force threshold) may select the item, and an indication of the selection may be provided to the user via any convenient form of feedback such as highlighting or animation. Releasing at this point will cancel the selection and not launch the application or activate the selected item. To perform an activation of the selected item, a harder press (past a second threshold) will perform the actual launch or activation of the selected item. In some embodiments, the activation of the selected item will occur after a complete (e.g., below the first force threshold) or partial lift (e.g., below the second threshold) of the input object from the input surface of the input device.

The embodiments described above relating to Tables 1 and 2 are only two examples of how force information can be used by an indirect interaction device to emulate a direct interaction device. The processing system of the input device may respond with a variety of interface actions configured for direct interaction on an indirect interaction device.

In various embodiments, the processing system is configured to provide user feedback for various events, such as switching from cursor mode to emulation mode, item selection, item activation, or when the first or second force thresholds are met. Examples of user feedback may include auditory, haptic or visual. Furthermore, the various force thresholds for each action may be dynamically set by the user for a customized experience.

In one embodiment, the second force threshold can be used to extend gestures by mapping a range of force to control a parameter such as speed. For example, when a user performs an action such as a scroll, rotate, or zoom, the amount of force applied can modulate the speed of the scroll, zoom, or rotate. Applying additional force could continue the action after the user has run out of space on the input surface. This means that users will not have to reinitiate action, and gives more flexibility for the speed of the action.

It should be understood that multiple force level thresholds may be used to provide advanced functionality. Furthermore, when there are multiple input objects interacting with the touch surface, the total or individual amount of force for the multiple objects may be used to control action parameters. That is, for a force sensor comprising multiple force sensing sub-regions, force may be detected and processed on a per finger basis.

In one embodiment, the entire range of the interface action may be mapped to a range of force information. For example, it is possible to map the entire range of magnification of a picture (full zoomed-in to fully zoomed-out) to a range of force. This make the unidirectional force input to control a bidirectional task. In order to select a zoom level from fully zoomed-out state, user applies force and selects the zoom level (latching) by using the selection method described. To change the zoom level, the user has to first apply force equal to or great than the current force mapped to the zoom level (unlatching) and then new zoom level can be selected

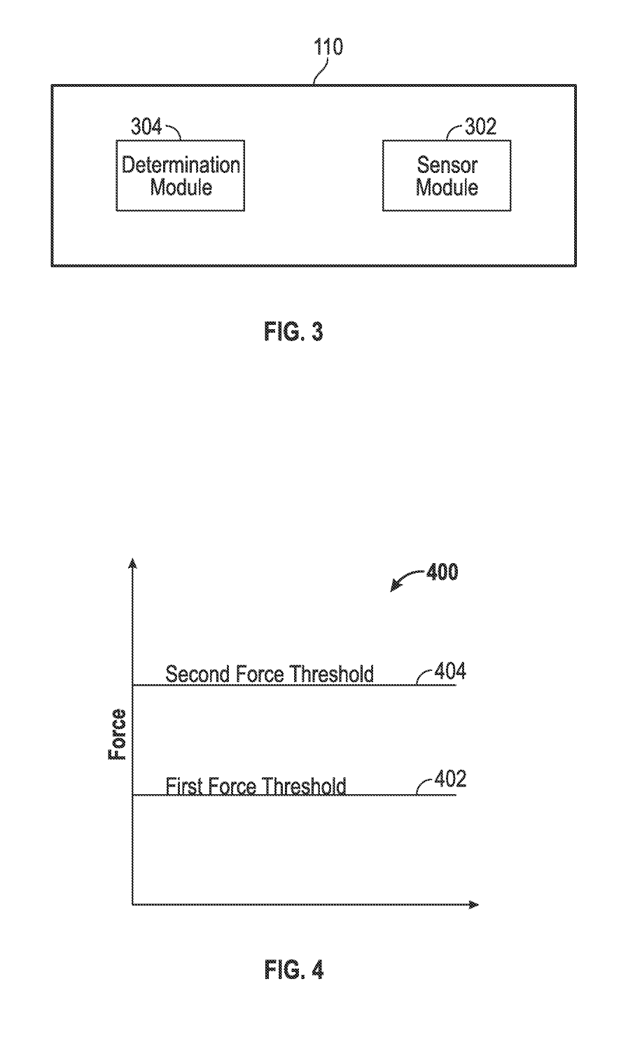

Referring now to FIGS. 1 and 3, the processing system 110 includes a sensor module 302 and a determination module 304. Sensor module 302 is configured to receive resulting signals from the sensors associated with sensing region 120. Determination module 304 is configured to process the data, and to determine positional information and force information. The embodiments of the invention can be used to enable a variety of different capabilities on the host device. Specifically, it can be used to enable the cursor positioning, scrolling, dragging, and icon selection, closing windows on a desktop, putting a computer into sleep mode, or perform some other type of mode switch or interface action.

Referring now to FIG. 4, a force plot 400 illustrates a first force threshold value 402 and a second force threshold value 404, although additional or less values (levels/thresholds) may also be implemented in the context of the present invention. These various force thresholds may be applied to a single force sensing region or to multiple force sensing sub-regions.

With continued reference to FIG. 4, an exemplary force level mapping (FIG. 4) may correspond to force applied in any one (or more) sub-regions of the sensing surface to permit per finger force determinations. Examples of sub-regions may include a bottom “button” area of an input surface, and corners and edges of the input surface. The force level mapping comprises one or more force levels indicating the amount of force applied to each sub-region of the sensing region, which may be configured to detect a large number of force levels, only a few force levels, or one force level. The force levels may be segmented by force thresholds which establish boundaries (e.g., upper, lower, or both) between force ranges. Force ranges may be associated with various functions, (i.e., first action, second action, third action, etc.) such that it is possible for the user to activate a given function by applying a given force to a sub-region of the touchpad. The number of force ranges and values of force thresholds may be based on the number of force levels that can be distinguished by the input device, the number of functions to be performed, and the ability of the user to reliably apply a desired amount of force on the input device, among other factors. While FIG. 4 illustrates a first and second force threshold, in other embodiments, more or less than two force thresholds may be used.

For example, force information corresponding to an applied force that is greater than and/or equal to the first force threshold and less than and/or equal to the second force threshold may be indicative of a first action. Force information corresponding to an applied force that is greater than the first force threshold and greater than and/or equal to the second force threshold is indicative of a second action.

The above examples are intended to illustrate several of the functions that could be performed for various degrees, levels, thresholds, or ranges of force. Other functions that could be performed for a given level of force include, but are not limited to, scrolling, clicking (such as double, triple, middle, and right mouse button clicking), changing window sizes (such as minimizing, maximizing, or showing the desktop), and changing parameter values (such as volume, playback speed, brightness, z-depth, and zoom level).

It is also possible to adjust the sensitivity of the input device by changing the force thresholds. These configurations can be performed manually by the user via software settings. Alternatively, or in addition to, various touch algorithms can automatically adjust one or more force thresholds (e.g., based on historical usage data).

In various embodiments, visual, audible, haptic, or other feedback may be provided to the user to indicate the amount of force has been applied. For example, a light can be illuminated or an icon displayed to show the amount of force applied to the input device. Alternatively, or in addition to, a cue, such as an icon of the layout, can be displayed on screen.

FIG. 2 is a flow chart illustrating a method 200 of operating an electronic system to emulate a touch sensitive interface using a touchpad and a display screen which does not overlap the touchpad. The method 200 includes determining (task 202) positional information and force information for an input object in a sensing region of the touchpad, positioning (task 204) an input object representation on the display screen based on the positional information, and selecting (task 206) a user selectable item on the display screen based on the force information satisfying a first force threshold (e.g., having a force value greater than the first force threshold). In one embodiment, the method 200 includes activating (task 208) the item positioned coincident with the input object representation on the display screen based on the force information satisfying a second force threshold (e.g., having a force value greater than the second force threshold). In another embodiment, the method 200 includes activating (task 208) the item positioned coincident with the input object representation on the display screen based on the force value reducing below the first and/or second threshold. In another embodiment, the method 200 includes activating (task 208) the item positioned coincident with the input object representation on the display screen based on a removal of the input object from the input surface of the input device (i.e., the force information indicative of no force applied to the input surface).

An input device is thus provided for use with a host computer system of the type which includes a graphical user interface configured to display user selectable items. The input device includes a touchpad configured to detect input objects in a sensing region of the touchpad, and a processing system communicatively coupled to the host and to the touchpad. The processing system configured to: determine positional information and force information for an input object in the sensing region; control the position of an input object representation on the graphical user interface based on the positional information of the input object; control the selection of an item based on a force imparted to an input surface of the touchpad by the input object satisfying a first force threshold; and control the activation of the selected item (e.g., the item positioned coincident with the input object representation on the display screen) based on the force imparted to the input surface by the input object satisfying a second force threshold after satisfying the first force threshold. Alternatively, activation of the item positioned coincident with the input object representation on the display screen is based on the force value reducing below the first and/or second threshold, and/or based on a removal of the input object from the input surface of the input device (i.e., the force information indicative of no force applied to the input surface).

In an embodiment, the input object representation comprises a graphical representation of one of: a cursor; a pointer; a finger; and a stylus, and the graphical user interface and the touchpad are non-overlapping.

In another embodiment, the second force threshold is greater than the first force threshold, and activation of the selected item may be based on a full or a partial release of the increased force level. Moreover, activation of a selected item may be canceled in response to lift off of the input object from the input surface before and/or without satisfying the second force threshold. The second force threshold may be satisfied by removing the input object from the input surface.

In an embodiment, the item may be an interface action which emulates a user selectable item on a touch sensitive display screen.

In another embodiment, activation of a selected item may be canceled in response to a time out of a predetermined duration after reaching the force threshold. Further, activation of the selected item may involve launching an application

In another embodiment, the processing system may be configured to provide visual feedback on the graphical user interface representing at least one of the position of the input object representation, item selection, and item activation.

In an embodiment, the touchpad is configured to separately detect proximity information and force information for a plurality of input objects.

In one embodiment, the processing system is configured to map positional information between the touchpad and the graphical user interface in an absolute manner. In other embodiments, the processing system may be configured to map positional information between the touchpad and the graphical user interface in a relative manner.

A method is also provided for operating an electronic system to emulate a touch sensitive interface using a touchpad and a display screen which does not overlap the touchpad. The method includes determining positional information and force information for an input object in a sensing region of the touchpad; positioning an input object representation on the display screen based on the positional information; selecting a user selectable item on the display screen positioned coincident with the input object representation on the display screen based on the force information satisfying a force threshold; and activating the selected item based on the force information satisfying the first force threshold and/or a second force threshold. In some embodiments, activating the selected item is further based on the force information satisfying a reduction in the force imparted on the surface past the first and/or second threshold.

The method further involves operating the touchpad and the display screen in a cursor mode wherein the input object representation comprises a cursor, and wherein the cursor is positioned on the display screen based on the positional information; operating the touchpad and the display screen in an emulation mode wherein the input object representation comprises a graphical finger, and wherein the finger selects and activates the item based on the force information; and switching between the cursor mode and the emulation mode. In an embodiment, switching between modes may be based on one of: an instruction from a host operating system associated with the display screen; an instruction from a driver associated with the touchpad; and a user gesture.

The method may also include configuring the driver to convert the positional information and force information into emulated touch sensitive interface data, and to communicate the data to the host operating system.

In an embodiment, the second force threshold is satisfied by removing the input object from the input surface, and/or activation of a selected item may be canceled in response to lift off of the input object from the input surface before satisfying the second force threshold.

A processing system is also provided for use with a force enabled touchpad, wherein the processing system includes a sensor module and a determination module. In an embodiment, the sensor module may be configured to detect input objects in a sensing region of the touchpad and to generate resulting signals comprising positional information and force information for an input object. The determination module may be configured to: control the position of an input object representation on a display screen based on the positional information; control the selection of an item on the display screen based on a force imparted to an input surface of the touchpad by the input object satisfying at least a first force threshold; and control the activation of the selected item based on the force imparted to the input surface by the input object satisfying at least the first force threshold.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Other embodiments, uses, and advantages of the invention will be apparent to those skilled in art from the specification and the practice of the disclosed invention.

What is claimed is:

1. An input device for use with a host system of the type which includes a graphical user interface configured to display user selectable items, the input device comprising;
a touchpad configured to detect input objects in a sensing region of the touchpad; and
a processing system communicatively coupled to the host and to the touchpad, the processing system configured to:
determine positional information and force information for an input object in the sensing region;
control the position of an input object representation on the graphical user interface based on the positional information of the input object;
control the selection of an item based on a force imparted to an input surface of the touchpad by the input object satisfying a first force threshold; and
control the activation of the selected item based on the force imparted to the input surface by the input object satisfying a second force threshold after satisfying the first force threshold.

2. The input device of claim 1, wherein the input object representation comprises a graphical representation of one of: a cursor; a pointer; a finger; and a stylus.

3. The input device of claim 1, wherein the graphical user interface and the touchpad are non-overlapping.

4. The input device of claim 1, wherein the second force threshold is greater than the first force threshold.

5. The input device of claim 4, wherein activation of the selected item is further based on a full or a partial release of the input object.

6. The input device of claim 4, wherein activation of a selected item is canceled in response to lift off of the input object from the input surface before satisfying the second force threshold.

7. The input device of claim 1, wherein the second force threshold is satisfied by removing the input object from the input surface.

8. The input device of claim 1, wherein the item comprises an interface action which emulates a user selectable item on a touch sensitive display screen.

9. The input device of claim 1, wherein activation of a selected item is canceled in response to a time out of a predetermined duration.

10. The input device of claim 1, wherein activation of the selected item comprises launching an application

11. The input device of claim 1, wherein the processing system is further configured to provide visual feedback on the graphical user interface representing at least one of the position of the input object representation, item selection, and item activation.

12. The input device of claim 1, wherein the touchpad is configured to separately detect proximity information and force information for a plurality of input objects.

13. The input device of claim 1, wherein the processing system is further configured to map positional information between the touchpad and the graphical user interface in an absolute manner.

14. The input device of claim 1, wherein the processing system is further configured to map positional information between the touchpad and the graphical user interface in a relative manner.

15. A method of operating an electronic system to emulate a touch sensitive interface using a touchpad and a display screen which does not overlap the touchpad, the method comprising:
determining positional information and force information for an input object in a sensing region of the touchpad;
positioning an input object representation on the display screen based on the positional information;
selecting a user selectable item on the display screen based on the force information satisfying a first force threshold; and
activating the selected item based on the force information satisfying the first force threshold and a second force threshold.

16. The method of claim 15, further comprising:
operating the touchpad and the display screen in a cursor mode wherein the input object representation comprises a cursor, and wherein the cursor is positioned on the display screen based on the positional information;
operating the touchpad and the display screen in an emulation mode wherein the input object representation comprises a graphical finger, and wherein the finger selects and activates the item based on the force information; and
switching between the cursor mode and the emulation mode based on one of:
i) an instruction from a host operating system associated with the display screen;
ii) an instruction from a driver associated with the touchpad; and
iii) a user gesture.

17. The method of claim 16, wherein the driver is configured to convert the positional information and force information into emulated touch sensitive interface data, and to communicate the data to the host operating system.

18. The method of claim 16, wherein the second force threshold is satisfied by removing the input object from the input surface

19. The method of claim 16, wherein activation of a selected item is canceled in response to lift off of the input object from the input surface before satisfying the second force threshold.

20. A processing system for use with a force enabled touchpad, comprising:
a sensor module configured to detect input objects in a sensing region of the touchpad and to generate resulting signals comprising positional information and force information for an input object; and
a determination module configured to:
control the position of an input object representation on a display screen based on the positional information;
control the selection of an item on the display screen based on a force imparted to an input surface of the touchpad by the input object satisfying a first force threshold; and
control the activation of the selected item based on the force imparted to the input surface by the input object satisfying the first force threshold and a second force threshold.
